(19) United States
(12) Patent Application Publication
(10) Pub. No.: US 2024/0025115 A1
(43) Pub. Date: Jan. 25, 2024

(54) 3D PRINTER HEAD

(71) Applicant: CONNECT4ENGINEERING LTD, London (GB)

(72) Inventor: Bobby Singh, London (GB)

(21) Appl. No.: 18/258,373

(22) PCT Filed: Dec. 21, 2020
(86) PCT No.: PCT/GB2020/053330

§ 371 Date: Jun. 20, 2023

(51) Int. Cl. B29C 64/209; B33Y 10/00; B33Y 30/00; B29C 64/118; B29C 64/314; B29B 7/80; B29C 64/336

(52) U.S. Cl. CPC B29C 64/209; B33Y 10/00; B33Y 30/00; B29C 64/118; B29C 64/314; B29B 7/80; B29C 64/336

(57) ABSTRACT

The present invention relates to an additive layer manufacturing device comprising a printer head configured to provide deposition of an extrudate in use. A printer head for a fused deposition modelling printer is disclosed. The printer head comprises a body having a chamber for holding material to be deposited by the printer head through an output aperture. A heating element heats material contained within the chamber. A cover member is moveable relative to the output aperture so as to vary the amount of the output aperture that is uncovered such that material can be extruded therethrough. A first feed system is configured to feed a first material to the printer head. A second feed system is configured to feed a second material to the printer head. The device may comprise a mixing system configured to mix the first and second material in the printer head, such that the extrudate comprises a mixture of the first and second material.

The present invention relates to a printing system and/or printer head for an extrusion-based Additive Layer Manufacturing (ALM) printer.

Fused Filament Fabrication (FFF) or Fused deposition modelling (FDM) is a 3D printing (ALM) process that heats a continuous filament of a thermoplastic material before controlling its deposition through a nozzle to form a printed work piece. Conventionally, filament is fed from a large coil through a heated printer extruder head, and is deposited on to a growing work piece, the printer head moving during deposition to define the shape of the work piece. Usually, the head moves in two dimensions to deposit one horizontal plane, or layer, at a time. The work or the print head is then moved vertically by a small amount to begin a new layer.

Although FDM is a popular method, particularly for low-grade printing jobs as a result of its low cost, FDM does have limitations. One particular problem is that the nozzle through which the material is deposited has a fixed diameter, and thus material can only be applied to the work piece with a fixed thickness. Thus, the nozzle head has to be removed and replaced with a different nozzle head each time the user intends to change the thickness of deposited material, which is time consuming. It also makes varying the thickness across a single layer of deposition very difficult.

There has now been devised an improved printer head, which overcomes or substantially mitigates disadvantages associated with the prior art.

According to a first aspect of the invention there is provided: a printer head for an extrusion additive layer manufacturing printer, the printer head comprising: a body comprising a chamber for holding material to be deposited by the printer head, at least one heating element for heating material contained within the chamber and an output aperture through which material can be extruded for deposition onto a working area during use; and a cover member moveable relative to the output aperture so as to selectively vary the amount of the output aperture that is uncovered such that material can be extruded therethrough.

Optionally, the outlet aperture is elongate in form and the cover member is movable in a direction of a longitudinal axis of the outlet aperture.

Optionally, the cover member is continuously movable between a first position in which a majority or all of the outlet aperture is uncovered and a second position in which a majority or all of the outlet aperture is covered.

Optionally, the cover member is continually moveable between the first and second positions to vary the uncovered area of the outlet aperture.

Optionally, the output aperture being profiled and/or having a width that varies along its length.

Optionally, the output aperture having a width that continuously varies along its length.

Optionally, the cover member comprises an aperture which is selectively moveable over the outlet aperture.

Optionally, the aperture of the cover member has a width that varies along its length.

Optionally, the aperture of the cover member has a width that continuously varies along its length.

Optionally, the cover and/or body aperture is rectangular.

The output aperture may be rectangular and/or the effective outlet defined between the output aperture and the cover member is rectangular and/or square.

The effective outlet defined between the output aperture and the cover member may comprises a constant shape/aspect ratio with varying size of the effective outlet. The output aperture and the cover member aperture may comprise a double diamond arrangement (i.e. the corners of the rectangle face one another). The output aperture and the cover member aperture may be similar or identical in shape.

Optionally, the width of the aperture of the cover member varies in an opposite direction along its length to which the width of the output aperture varies along its length.

Optionally, the cover member is positioned externally of the printer head body and/or overlies the outlet aperture.

Optionally, the cover member is a cover shell that fits over or around the printer head body.

Optionally, the cover member is slidable and/or rotatable relative to the printer head body.

Optionally, the printer head further comprises an output channel for delivering the material from the chamber to the output aperture, the output channel traversing between a first end for receiving material from the chamber and a second end positioned at or near the output aperture.

Optionally, the heating of the material in the chamber generates an internal pressure for driving material flow along the output channel to the output aperture.

Optionally, the at least one heating element further arranged for heating at least a portion of the output channel.

Optionally, the heating element extends in a radial and/or spiral direction over an internal area of the body and/or chamber.

Optionally, an inlet opening for the chamber in a side of the body, e.g. centrally and/or in a side that is offset from the outlet aperture.

Optionally, the output aperture is rectangular. Optionally, the cover aperture is rectangular. Optionally, the vertices of the respective apertures are facing. Optionally, the cover aperture and body aperture comprise a double diamond arrangement. Optionally, the effective deposition outlet defined between the output aperture and the cover member is rectangular.

Optionally, the print head comprises a plurality of inlets configured to receive a respective extrudate material and the print head comprises a mixing system to mix the materials to provide an extrudate comprising a mixture of the materials. Optionally, the inlets are operatively connected to respective feed systems.

Optionally, the inlets are provided on opposing sides of the print head.

Optionally, print head is supported on a carriage. Optionally, the cover and/or body are actuable by respective actuators provided on the carriage. Optionally, the cover and/or body are operatively connected to the respective actuators via rotatable shafts. Optionally, the rotatable shafts comprise bevel gears.

Optionally, the first and/or second feed system are supported on the carriage.

Optionally, the carriage comprises a plurality of mounted to allow movement of there carriage in a 2D plane.

Both the output aperture and the cover member may be rotatable to allow movement of the effective output aperture (e.g. to allow rotation of the effective output aperture). The effective output aperture may be rotatable about the axis of rotation of the cover member and the output aperture.

According to a second aspect of the invention, there is provided: a method of manufacturing a product by fused deposition modelling comprising: feeding plastics material to a printer head of a three-dimensional printer according to any preceding claim; and moving the cover member relative to the output aperture so as to selectively vary the thickness of material being extruded from the printer head by altering the amount of the output aperture that is uncovered.

Optionally, the thickness of the material is varied during a single print job and/or between successive print jobs.

According to a third aspect of the invention, there is provided: an additive layer manufacturing device comprising: a printer head configured to provide deposition of an extrudate in use; a first feed system configured to feed a first material to the printer head; a second feed system configured to feed a second material to the printer head; and where the device comprises a mixing system configured to mix the first and second material therein, such that the extrudate comprises a mixture of the first and second material.

Optionally, the mixing system comprises: a plurality of inlets configured to receive the first and second materials in use, and; a mixing chamber fluidly connected to the inlets such that the first and second materials are mixed within the mixing chamber in use.

Optionally, the mixing chamber comprises one or more flow disruptor configured to disrupt the flow of the materials to encourage mixing thereof. Optionally, the flow disruptors are pillars or the like. Optionally, the flow disruptors are cylindrical Optionally, the mixing system comprises one or more tortuous channel fluidly connected to each of the inlets, such that the materials are mixed within the channel in use.

Optionally, the tortuous channel comprises a plurality of tight turns.

Optionally, the channel is operatively located between the mixing chamber and an outlet of the mixing system. Optionally, a flow disruptor is provided adjacent an inlet to the tortuous channel.

Optionally, a first mixing system is provided in the printer head, such that the first and second material are configured to be mixed therein.

Optionally, a second mixing system is provided in the second feed system, such that a plurality of different materials can be mixed to provide the second material. Optionally, the mixing chamber is provided in the second feed system. Optionally, the second mixing system is mounted to a carriage configured to support the print head.

Optionally, one of the first and second material comprises a base material and the other of the first and second material comprises an additive configured to alter or augment one or more property of the base material. Typically, the base material comprises a bulk material for a 3D printed article.

Optionally, the additive comprises one or more of: a binding material; a curing/setting agent; a filler; a functional material; or a reinforcing material.

Optionally, the functional material comprises an additive configured to alter the thermal/electrical insulative/conductive properties of the base material.

Optionally, the reinforcing material comprises one or more fibre to provide a composite extrudate. Optionally, the fibre is provided by the second feed system. Optionally, the fibre comprises a filament fibre.

Optionally, the extrude comprises a cementitious material (e.g. concrete or cement).

Optionally, the mixing system mixes a dry cementitious material with a fluid (e.g. water) and/or an aggregate.

Optionally, the base material comprises a thermoplastic and/or thermoset.

Optionally, one of the first and second material comprises a colourant (e.g. a dye or pigment).

Optionally, where the mixing system is configured to receive a plurality of different colourants and the mixing system mixes the colourants to provide a single resultant colourant. Optionally, the input flow rate of the different colourants is varied to selectively vary the colour of the resultant colourant. Optionally, the colourant mixing system is operatively connected to the second feed system.

Optionally, the different colourants comprise colourant for each of the respective colours in a primary colour model (e.g. RGB or CMYK model).

Optionally, the first and a second feed system are operatively connected to the printer head via respective conduits, and where the conduits are operatively connected to the printer head on opposing sides thereof.

Optionally, the extrudate and/or the second material are substantially homogenous (e.g. provide a homogenous mix).

According to fourth aspect of the invention, there is provided: a method of additive layer manufacturing comprising: depositing an extrudate using a printer head; feeding a first material to the printer head; feeding a second material to the printer head; and mixing the first material and second material such that the extrude comprises a mixture of the first and second material.

Optionally, the method comprises receiving a plurality of different materials, and mixing the different materials such that the second material comprises a mixture of the plurality of different materials before the second material is fed into the printer head.

Optionally, the method comprises selectively mixing a plurality of different colourants to provide a single resultant colourant and the feeding the resultant colourant to the printer head.

According to a fifth aspect of the invention, there is provided: a three-dimensional printer comprising the printer head according to the first and/or third aspect of the invention.

Further optional features are recited in the associated dependent claims. The aperture in either or both of the cover or body may be profiled, e.g. taking the form of an eye, teardrop or other form that varies in width.

The variable open area of the output aperture allows different thicknesses/widths of material to be extruded through the output aperture onto the work area during printing.

This can be changed during use without needing the printer head to be changed. For example, the cover member can be moved to change the open area of the outlet aperture as part of a single/continuous instance of printing.

Heating of the material being deposited may be constant during alteration of the output aperture area. The flow of material through the output aperture during deposition may not be halted or may be halted for a minimal period of time during variation on the output aperture open area.

A single 3D printed structure may therefore have different thicknesses of extrudate in different regions thereof, e.g. allowing for variation in wall thicknesses in the printed structure and/or allowing variation in the rate at which regions of the structure are printed.

A varying profile of the output aperture may also allow tailoring of the shape of the extrudate as it leaves the printer head.

Any essential or preferable feature defined in relation to any one aspect of the invention may be applied to any other aspect of the invention wherever practicable. Accordingly, various combinations of the above features or claims are to be accommodated by way of the disclosure herein.

Practicable embodiments of the invention will now be described, by way of example only, with reference to the accompanying drawings, of which:

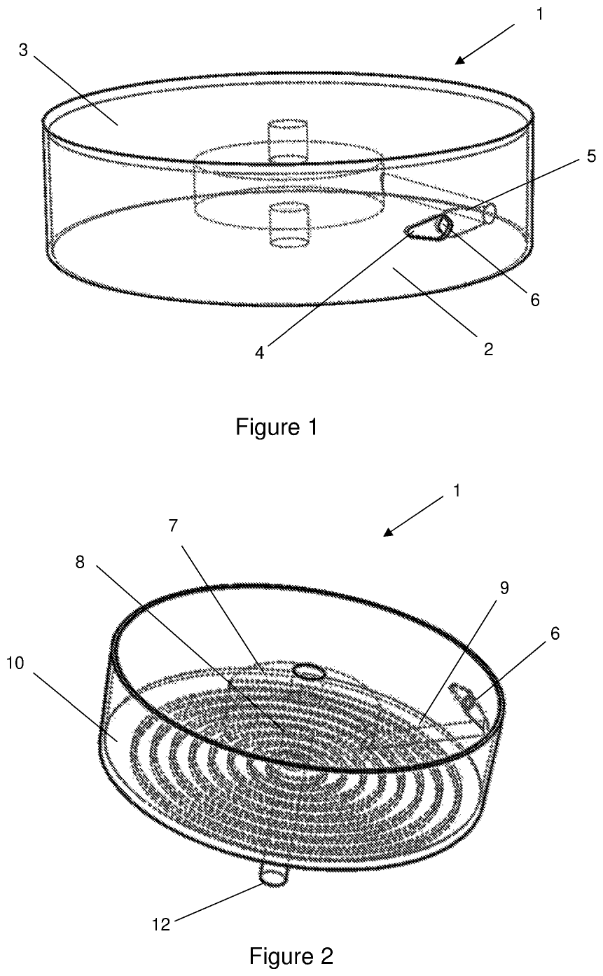

FIG. 1 is a first perspective wireframe view of a printer head;

FIG. 2 is a second perspective wireframe view of a printer head showing further details;

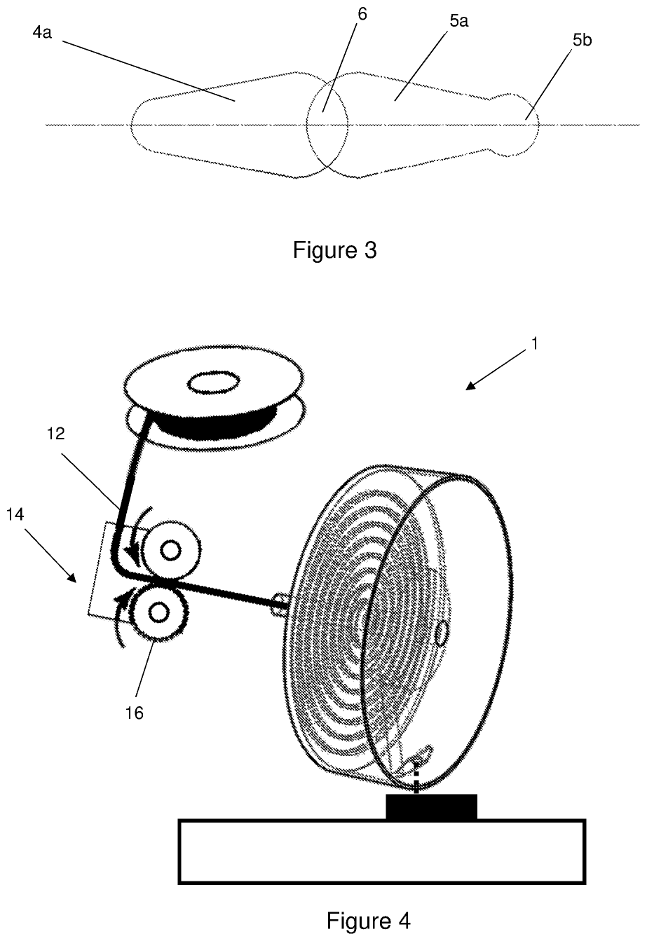

FIG. 3 shows a plan view of a deposition aperture of the printer head;

FIG. 4 shows a three-dimensional printer arrangement;

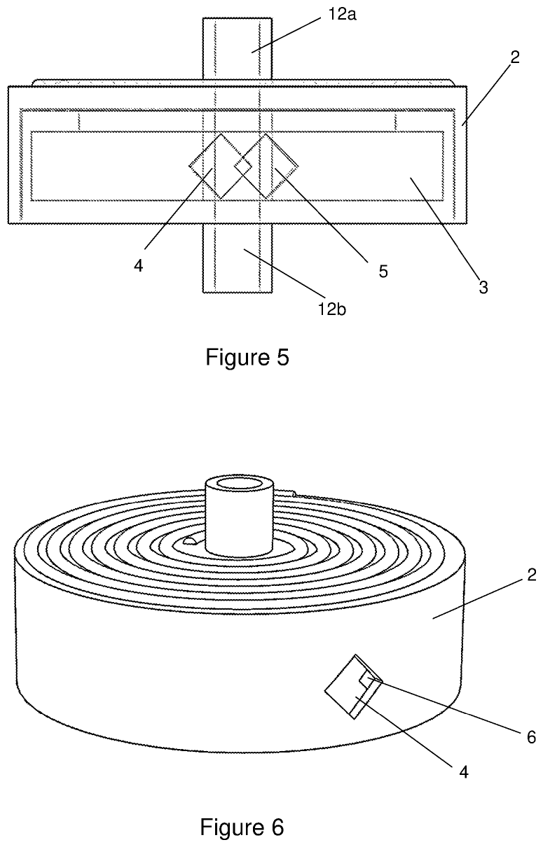

FIG. 5 shows a wireframe view of a second embodiment of the printer head;

FIG. 6 shows a perspective view of a second embodiment of the printer head;

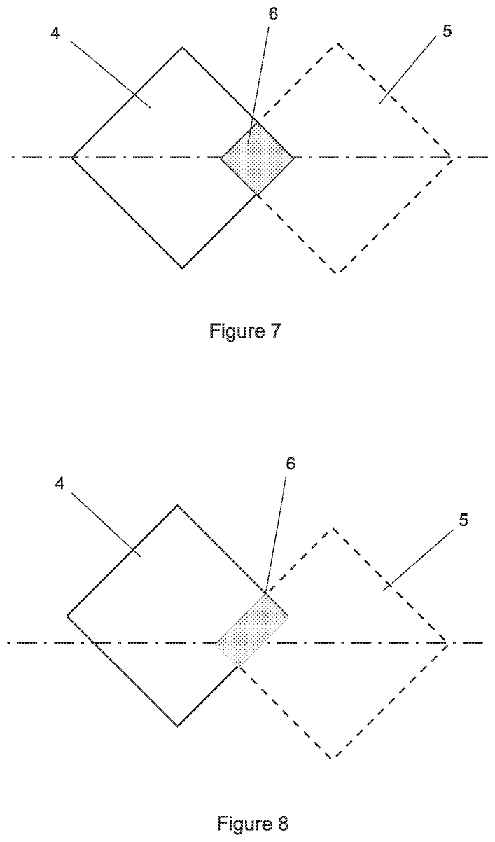

FIG. 7 shows a plan view of the deposition aperture of the second embodiment of the printer head;

FIG. 8 shows a plan view of the deposition aperture of a third embodiment of the printer head;

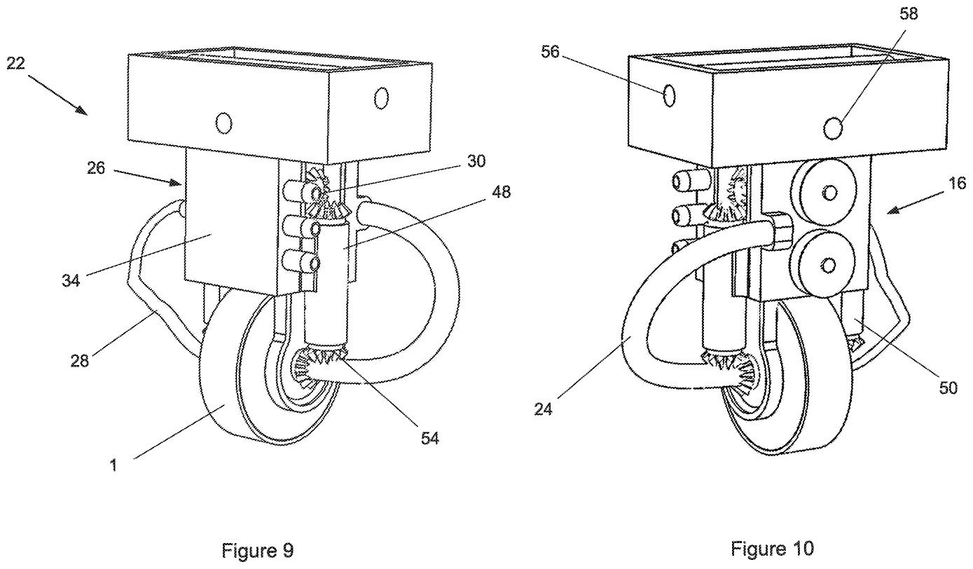

FIGS. 9 and 10 show perspective views a third embodiment of the printer head arrangement;

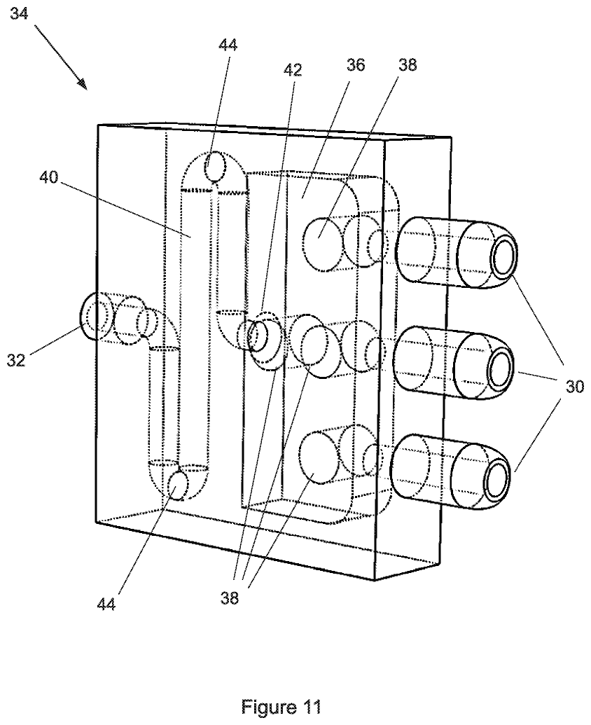

FIG. 11 shows a schematic view of a mixing system.

FIG. 1 illustrates a printer head 1 according to an embodiment of the invention. Those lines that are dashed represent features that would not be seen externally by a user from the shown viewing angle.

In use, the printer head 1 is configured to deposit an extrudate (i.e. a material extruded from the head 1) as part of an additive layer manufacturing (ALM) process.

The printer head 1 is substantially cylindrical in form in this example. The printer head 1 comprises a cover shell 2, and a body 3. The body and shell may both be cylindrical. The cover shell 2 and/or body 3 may have a major face and a side wall extending about the circumference of the major face. The printer head is thus puck-like in form.

The side wall of the cover shell 2 overlies the side wall of the body 3.

The cover shell 2 is hollow and receives the body 3 therein. The body 3 is held within the shell 2 in a close-fitting arrangement, i.e. so that the body side wall is immediately adjacent the shell side wall.

The cover shell 2 comprises an aperture 4 in the side wall thereof, and the body 3 comprises an aperture 5 in the corresponding side wall thereof. Where the apertures 4, 5 overlap there is an outlet through which material may be extruded, herein referred to as the deposition outlet 6.

The cover shell 2 is movable relative to the body 3 so as to selectively vary the overlap of their respective apertures 4, 5. In this example, the cover shell 2 is rotatable relative to the body 3 but could be otherwise slidable in other examples. This in turn varies the open/exposed area of the deposition outlet 6, thus varying the density/thickness/width of material deposited through the deposition outlet 6 in use.

Relative rotational movement between the cover shell and body 3 may be effected using a conventional actuator of known type, e.g. under the control of a controller, and will not be described in detail, save to say that the desired movement may be powered by electric/electronic actuator. The actuator may be numerically controlled. The actuator could comprise a servo motor (e.g. which is programmable).

The cover shell 2 may be actuated and the body may be fixed, or vice versa. In some examples, both the cover shell and body could be actuatable, e.g. to vary to location and/or area of the outlet 6.

In a specific example, the body and cover shell move relatively at the same time, e.g. in opposite directions. The objective of the opposing motion may be to constrain/fix or control the location of the deposition outlet 6 relative to a layer or object being printed by the print head. The motion of the body and cover shell may be controlled so that the deposition outlet 6 remains perpendicular to a current print layer of an article being printed. A centre or end of the deposition outlet may be controlled to remain in a constant, e.g. angular, location relative to the axis of rotation or a workpiece/surface or layer thereof being printed.

The motion of cover shell and body may be controlled so that they undergo the same ratio/motion, e.g. but in opposing directions.

Each of the apertures 4, 5 extends along the side wall of the respective cover shell 2 and body 3, e.g. in the circumferential direction in this example. Either or both aperture 4, 5 has a non-uniform profile in said direction. For example, either or both aperture gradually varies in width along its length.

The profile/shape of each of the apertures 4, 5 gradually varies in width in opposite directions, i.e. the aperture 4 gradually decreases in width from right to left as shown in FIG. 1, and the aperture 5 gradually decreases in width from left to right. This means that as the cover shell 2 is rotated relative to the body 3, the shape/profile of the deposition outlet 6 may also be selectively variable.

FIG. 2 illustrates the internal features of the printer head 1 of FIG. 1. Again, those lines that are dashed represent features that would not be seen externally by a user. Here it can be seen that the printer head further comprises an internal chamber 7 for holding material to be deposited by the printer head 1.

The chamber 7 thus provides an internal reservoir within the body, from which a continuous volume of material can be dispensed in use through a chamber outlet.

Material 12 is fed to the chamber 7 via an inlet opening 8 and delivered from the chamber 7 to the deposition outlet 6 by outlet channel 9.

Whilst stored in the chamber 7, the material is heated by heating element 10, so as to melt the material (or maintain it in a melted form at a desired temperature), so that it can flow through the deposition outlet 6 and conform to the desired profile defined by the shape of the deposition outlet 6, i.e. being extruded through the outlet.

The heating element 10 may be any conventional heating element, and is preferably electrically powered.

The outlet channel 9 may be an enclosed or open-sided duct extending from the chamber 7 radially outwardly to the aperture 5, i.e. to convey molten material from the chamber to the outlet 6. The channel thus guides the flow of material so that it correctly enters the aperture in a consistent/laminar manner.

In some examples the flow of material could otherwise be directed under gravity or using some other guide formation. In this example, volumetric expansion during the high temperature meting procedure is used to create a positive pressure within the chamber 7, which drives the flow along the enclosed channel 9 to the deposition outlet 6. The flow may therefore be described as being self-driven by virtue of the heating process.

A helical heating element is shown in this example, which extends radially outwardly from a central region where the material 12 enters the chamber 7 via the inlet 8. The heating element thus heats the material in the chamber 7 and also as it flows to the deposition outlet 6, i.e. to maintain the desired temperature until the point of exit from the body 3. A heating element is provided on each side of the body 3. Other heating element arrangements could be used to this end as desired.

FIG. 3 shows a further example of the apertures 4a and 5a. Either or both aperture may be at-least partially curved in form, e.g. towards either or both end. Either or both aperture may be teardrop shaped. Either or both aperture may have a tapering/narrowing tail section.

The aperture 5a in the body 3 may have a portion 5b arranged to receive molten material in use so it can be guided to flow along the aperture 5a to the overlap with the aperture 4a. This portion 5b is shown in FIG. 3 as being at the distal end of the aperture 5a, e.g. being generally circular in plan. The head 1 therefore deposits a generally circular, ovate or biconvex cross-section extrudate. Whilst portion 5b is aligned with the centreline of the aperture 5a, it may be offset from the centreline in a working example.

The apertures 4/4a and 5/5a may be aligned along a common centreline.

The outlet channel 9 is fixed relative to the body 3, such that outlet channel 9 remains aligned with aperture 5/5a, e.g. the portion 5b and/or distal end of the aperture 5/5a. Thus material flows along the aperture 5/5a until it reaches the exposed area defining the deposition outlet 6.

Whilst the examples above comprise apertures in both the cover shell 2 and body 3, it can be appreciated that a single aperture in the body of desired profile may be provided and the cover may selectively expose or cover said aperture. For example, the cover shell side wall may not be a complete annulus as shown in FIGS. 1 and 2 and may terminate at an edge. The edge/end of the cover shell may be drawn over the aperture in the body to selectively expose/cover the aperture in use. The edge could be profiled as desired, e.g. being curved or comprising an apex/recess.

In some examples, the cover shell may simply be referred to as a cover member and may only need to be of a size sufficient to fully occlude the aperture in the body. The cover member 3 may prevent leakage or relative dislocation of components 2 and 3, as well as performing its primary function of selectively exposing the aperture 5.

Whilst the above preferred examples refer to a cylindrical body, different forms, e.g. having a polygonal form, are possible. The cover member may take the form of a flat plate that slides over the aperture in a side wall or face of the body. The selective and variable exposure of the deposition aperture using a cover member may be common to all such examples.

FIG. 3 illustrates a 3D printer 14 comprising a printer head 1 of the type described in FIGS. 1-3.

In use, a continuous filament of plastics material 12, generally a thermoplastic, is delivered to the printer head 1 using a delivery mechanism 15, often referred to as an injector system. The delivery mechanism in this example takes the form of contrarotating rotors 16, at least one of which comprises a toothed wheel, so as to urge the plastics material 12 through the nip region between the rotors towards the printer head 1. The material filament may be delivered in solid form at ambient temperature, e.g. from a roll, such that it is heated to melt the material only when it enters the printer head 1.

The material filament 12 enters the printer head 1 via the inlet channel 8, and is melted, softened or otherwise rendered fluent within the chamber 7. The material resides in the chamber 7 for a time that the material is sufficiently molten/fluent. Melted material flows from the chamber 7 to the deposition outlet 6 via the outlet channel 9, and is deposited onto a work area to form a workpiece, which is typically positioned on a work bed 17 beneath the printer head 1.

The work bed may be a portion of the 3D printer or an external work surface. The work bed 17 may be moved to form the desired shape of the article being printed. Alternatively the print head may be moved relative to the work bed.

The cover shell 2 can be rotated relative to the body 3 so as to vary the area, width and/or shape of the deposition aperture as described above. This rotation may be effected during deposition of a single layer of material, to vary the density of material across that layer, or in between deposition of different layers, to vary the density of material between layers of material.

A controller that controls the relative movement between the printer head 1 and work bed 17 may also control the heater and/or deposition aperture 16 size of the printer head.

In some embodiments, both of the shell 2 and the body 3 are rotatable. This allows the effective aperture 6 to rotated to a new position (i.e. rotated about the rotational axis of the shell 2 and body 3). The printer 14 may therefore print in a non-vertical direction (e.g. print into the vertical side of a workpiece 17).

A second example of the printer head 1 is shown in FIGS. 5-7. The printer head is substantially the same as previously described and like features will not be described again. In this example, the apertures 4,5 on the cover 2 and body 3 respectively comprise a rectangular (e.g. square) shape.

As shown most clearly in FIG. 7, the apertures 4,5 are arranged such that the vertices 18 of the respective rectangular apertures are facing one another. The apertures 4,5 are aligned about a centreline 20. The apertures 4,5 therefore provide a “double-diamond” type arrangement. As the apertures overlap, a square deposition aperture 6 (shown in shading) is provided. The head 1 thus deposits a square cross-section extrudate. As the cover 2 and body 3 are relatively displaced, the size of the square deposition aperture 6 increases, up to a maximum size where the apertures 4,5 are fully aligned.

Provision of a square aperture allows a flat, planar 3D printed structure to be formed. This may be used to create walls etc. in printed products. For example this may be important in larger printed structures, such as buildings.

In the example in FIG. 8, the apertures 4,5 are offset from one another (i.e. one of the apertures is offset from the centreline 20 and/or the respective vertices 18 are not aligned). The apertures may be laterally offset with respect to the line 20. The deposition aperture 6 (shown in shading) thus comprises a rectangular shape. The size and/or aspect ratio of rectangular aperture 6 may therefore be determined by the degree of rotation/offset of the apertures 4,5.

In the examples shown in FIGS. 7 and 8, it can be seen that the shape/aspect ratio of the effective deposition aperture 6 remains constant with decreasing/increasing size thereof.

Thus, the cross-sectional shape/aspect ratio of the extrudate is always the same with different decreasing/increasing size. It can be appreciated that similar arrangements can be provided using triangular or chevron shaped apertures 4,5. This allows a consist build quality/profile.

It is foreseen that the aperture 5 of the body 3 could be constant in width over its length, the cover member aperture instead varying in width along its length, or being arranged to move relative to the aperture so as to vary the width of the aperture. The profile/width of either aperture may vary or be constant, e.g. in a plane of the surface of the body/cover, as required for particular applications.

In various examples, the outer/cover shell 2 may help prevent leakage of molten material from the body in use and/or may permit easy maintenance or cleaning internal components, e.g. by removal of the cover.

The internal body 3 and/or chamber may be formed of a single, metal component shaped/machined to provide the desired form. This may ease any manufacturing complexity.

The deposition aperture 6 may be described as a nozzle. The geometrical profile of the deposition aperture/nozzle may be customised to achieve a bespoke variable dispense nozzle opening. It can be appreciated that the apertures 4,5 and/or deposition aperture may be modified to provide an extrudate with any cross-sectional shape as required. For example, other polygonal and/or curved profiles may be used.

A second embodiment of the 3D printing system is shown in FIGS. 9 and 10. In this embodiment, the print head 1 is configured to receive a base deposition material and an additive material as will be described below.

The print head 1 is supported on a carriage system 22. The carriage system 22 will typically attached to an actuator or support structure to provide movement thereof. A base material feed system 16 is provided on the carriage 22 and is configured to feed base material 12a into the print head 1 for deposition thereof. The feed system 16 may be connected to the print head 1 via a hose/guide/conduit 24 or the like to contain the base material 12a therein.

An additive feed system 26 is provided on the carriage 22 and is configured to feed the additive material 12b into the print head. The additive feed system 26 may be connected to the print head 1 via a hose/guide 28 or the like to contain the additive material 12b therein.

The base feed system 16 and the additive feed system 26 are provided on opposing sides of the carriage. The respective hoses 24,28 connected to the print head 1 on opposing sides thereof. As best seen in FIG. 5, the base material 12a and the additive material 12b are introduced into the print head 1 from opposing sides of the print head 1. This causes the base material 12a and the additive material 12b to mix, thereby ensuring a homogenous mix. The print head 1 thus extrudes a single, mixed/homogenous extrudate.

The print head 1 therefore provides a mixing system to mix to different materials.

The hoses 24,28 may be connected about the rotational axis of the body 2/cover 3. The hoses 24,28 may be supported on the print head 1 via rotatable bearings or the like, thus allowing the body 2/cover 3 to rotate without interference therefrom.

The additive material 12b is configured to alter or augment one or more structural, physical or chemical characteristic for the base material 12a. For example, the additive 12b may comprise one or more of:
A colourant. The colourant may comprise a dye, pigment or a pre-coloured material configured to mix with the base material 12a. The colourant may change one or more of the colour, lustre, tone or lightness of the material. For example, the colourant could comprise reflective particles to provide a glitter effect.
A binding material. The binder provides adhesion/cohesion of the base material 12a to itself or previously depositing layers. For example, this may be used where the base material 12a comprises a power or loose material.
A curing/setting agent. This may cause base material 12a to cure or increase the curing rate thereof. For example, this may provide cross-linking of the base material 21a.
A filler material. This may be used to decrease the amount base material 12a used, or to increase the density thereof.
A functional additive. The additives may change the chemical, thermal and/or electrical properties thereof. For example, the additive may comprise an additive configured to improve the electrical conductivity of the base material 12a, such as graphite. Additionally or alternatively, the additive may comprise a thermally insulating or thermally conductive material. The functional additive may comprise a biocidal or anti-microbial material (e.g. Copper or Silver ions).
A reinforcing material. The reinforcing material is configured to reinforce the base materials 12a to provide a composite material. For example, the additive may comprise reinforcing filament fibres, staple fibres, particles and/or woven material.

In some embodiments, the base material 12a may comprise a cementitious material. The system may therefore be used to construct buildings. The additives may comprise one or more of: accelerators; air entraining agent; corrosion inhibitors; pigments; plasticisers; or retarders. Additionally or alternatively, one or additive material 12b and the base material 12b comprises a water and the other comprises cementitious dry mass (e.g. dry cement and/or aggregates). The water and the dry mass therefore mix in the print head 1 to cementitious slurry, which may then be deposited.

The additive feed system 26 is configured to receive a plurality of additives, for example, via plurality of inlets having associated inlet connectors 30. The additive feed system 26 is configured to mix or otherwise combine the plurality of additives to provide a single homogenous output additive 12b. The additive feed system 26 therefore comprises a single outlet 32 connected to the print head 1 via the hose 28.

The additive feed system 26 comprises a mixing system 34 configured to provide mixing of the plurality of additives. The mixing system 34 is shown in closer detail in FIG. 11.

The inlet connectors 30 are fluidly connected to a mixing chamber 36. The plurality of additives therefore flow from the respective connectors 30 and are mixed in the chamber 36. A plurality of flow disruptors 38 are provided proximal the respective inlet connector.

The flow disruptors 38 disrupt the linear flow of the additives, causing turbulent/random/chaotic flow thereof, thus further increasing the mixing. In the present embodiment, the flow disruptors 38 comprise cylindrical pillars. In other embodiments, the flow disruptors 38 may comprise a plurality of angled surfaces, gratings and/or constricted apertures. Additionally, the mixing chamber 36 and flow disruptors 38 balance the pressures of the inlet connectors 30 ensuring each of the additives is dispensed proportionally.

The mixing chamber 36 is fluidly connected to the outlet 32 via a serpentine/convoluted channel 40. A flow disruptor 38 may be provided proximal the inlet 42 of the channel 40.

The channel 40 comprises a plurality of tight turns 44 (e.g. right angles or U-turns), which introduces turbulent flow into the additives, thus enhancing mixing. The channel 40 and flow disruptors 38 provide mixing of additive without the use of moving parts. The mixing system 34 thus provides a passive/static mixing system.

In the present embodiment, the mixing system 34 is used to introduce a colourant into the base material 12b. The connectors 30 are therefore connected to a respective colour, which are mixed to provide an output colour. The flow of the respective colours can be varied accordingly to provide different resultant colours. For example, the connectors 30 are connected to a red, blue and green colourant respectively (i.e. the RGB colour model).

Alternatively, four connectors could be provided and a CMYK colour model could be used.

It can be seen that such an arrangement can be applied to other additives. The proportion of each additive in the output additive 12b can be varied by changing the respective flow rate thereof into the mixing system 34. This may be achieved by varying the supply pressure, flow speed or constricting the additive flow. This allows changing of the additive ratio (e.g. colour) in real time.

It can be appreciated that the number of inlet connectors 30 can be adjusted according to the number of additives required. Unused connectors 30 may be sealed via a removable cap or the like to prevent backflow of the additives. The additive feed system 26 may be used to provide only a single additive and the unused connectors 30 can be sealed accordingly.

In some embodiments, only the additive mixing system 34 may be used to provide the extrudate. The base material feed system 16 may be inactive or closed off. For example, this may be used if the colourant was pre-mixed with a base material, and thus mixing of the base material in the printer head 1 is not required.

Referring back to FIGS. 9 and 10, the actuation system 46 for the print head 1 is shown. A first actuator (not shown) is provided on the carriage 22. The first actuator may comprise an electric motor or the like. The cover 3 of the print head 1 is operatively connected to the first actuator via a first rotatable transmission shaft 48. The first actuator is therefore configured to effect rotation of the cover 3. In a similar arrangement, a second actuator is configured to effect rotation of the body 2 of the print head 1 via a second transmission shaft 50. The body 2 and cover 3 can therefore be actuated independently.

The transmission shafts 48,50 comprise bevel gears 52,54 at respective ends thereof, thus allowing the rotational axis of the shaft to be angled relative to rotational axis of the body/cover. This allows the actuators to be offset relative to the print head 1. One or both of the bevel gears 52,54 may comprise a non-unity gear ratio, thereby allowing fine adjustment of the deposition aperture 6 size.

The first feed system 16 and the second feed system 34 are mounted on the carriage 22.

The carriage 22 thus provides a self-contained printing system.

The carriage 22 may comprise a mount system to allow the carriage to be mounted to actuator or support structure in use. A first mount channel 56 is configured to receive a beam or like on the support structure. A second mount channel 58 is configured to receive a beam or like on the support structure. The first and second channels 56,58 extend in orthogonal directions, thus allowing movement of the carriage 22 in a 2D plane.

The present invention allows realtime adjustment of the deposition aperture size, therefore allowing complex shapes and structures to be 3D printed with ease. The printer can print on a number of scales due to the variable resolution thereof.

Additives may be added conveniently to the base material. The amount of additive may be changed in realtime, according to each design. The extrusion material colour may be changed and a near infinite combination of colours can be provided by mixing of the RGB colours.

The system ensures mixing of the base and the additives to ensure a homogenous extrudate is provided.

The above embodiments provide advanced print head mechanisms that are able to execute challenging and varied three-dimensional printing tasks. A material/additive induction mechanism and/or dual intake nozzle allow for variation in the material that is deposited. A colour, binding or strengthening element can thus be introduced to the material that is deposited by the print head.

The variable geometry extrusion outlet allows the extruded profile/size to be varied in cartesian coordinates. The above concepts can be applied to printing applications for large or small objects without departing from the principles described herein.

1. A printer head for a fused deposition modelling printer, the printer head comprising: a body comprising a chamber for holding material to be deposited by the printer head, at least one heating element for heating material contained within the chamber and an output aperture through which material can be extruded for deposition onto a working area during use; and a cover member moveable relative to the output aperture so as to selectively vary the amount of the output aperture that is uncovered such that material can be extruded therethrough.

2. A printer head according to claim 1, wherein the cover member is continually moveable between the first and second positions to vary the uncovered area of the outlet aperture.

3. A printer head according to claim 1, the output aperture being profiled and/or having a width that varies along its length.

6. A printer head according to claim 1, where the effective outlet defined between the output aperture and the cover member comprises a constant shape/aspect ratio with varying size.

12. A printer head according to claim 1, the printer head further comprising an output channel for delivering the material from the chamber to the output aperture, the output channel traversing between a first end for receiving material from the chamber and a second end positioned at or near the output aperture.

13. A printer head according to claim 12, wherein the heating of the material in the chamber generates an internal pressure for driving material flow along the output channel to the output aperture and for heating at least a portion of the output channel.

15. A printer head according to claim 12, wherein the heating element extends in a radial and/or spiral direction over an internal area of the body and/or chamber.

17. A printer head according to claim 1, where the print head comprises an inlet opening for the chamber in a side of the body or in a side that is offset from the outlet aperture and a plurality of inlets configured to receive a respective extrudate material and the print head comprises a mixing system to mix the materials to provide an extrudate comprising a mixture of the materials.

18. A printer head according to claim 1, where both the output aperture and the cover member are rotatable to allow movement of the effective output aperture.

19. A method of manufacturing a product by fused deposition modelling comprising: feeding plastics material to a printer head of a three-dimensional printer according to claim 1; and moving the cover member relative to the output aperture so as to selectively vary the thickness of material being extruded from the printer head by altering the amount of the output aperture that is uncovered.

21. An additive layer manufacturing device comprising: a printer head configured to provide deposition of an extrudate in use; a first feed system configured to feed a first material to the printer head; a second feed system configured to feed a second material to the printer head; and where the device comprises a mixing system configured to mix the first and second material therein, such that the extrudate comprises a mixture of the first and second material.

22. An additive layer manufacturing device according claim 21, where the mixing system comprises: a plurality of inlets configured to receive the first and second materials in use, and; a mixing chamber fluidly connected to the inlets such that the first and second materials are mixed within the mixing chamber in use.

23. An additive layer manufacturing device according to claim 22, where the mixing chamber comprises one or more flow disruptor configured to disrupt the flow of the materials to encourage mixing thereof.

24. An additive layer manufacturing device according to claim 22, where the mixing system comprises one or more tortuous channel fluidly connected to each of the inlets, such that the materials are mixed within the channel in use.

25. An additive layer manufacturing device according to claim 22, where the channel is operatively located between the mixing chamber and an outlet of the mixing system.

29. An additive layer manufacturing device according to claim 22, where the additive comprises one or more of: a binding material; a curing/setting agent; a filler; a functional material; one or more colourants; or a reinforcing material.

36. An additive layer manufacturing device according to claim 21, where the first and a second feed system are operatively connected to the printer head via respective conduits, and where the conduits are operatively connected to the printer head on opposing sides thereof.

38. A method of additive layer manufacturing comprising: depositing an extrudate using a printer head; feeding a first material to the printer head; feeding a second material to the printer head; and mixing the first material and second material such that the extrude comprises a mixture of the first and second material.

39. A method according to claim 38, comprising receiving a plurality of different materials, and mixing the different materials such that the second material comprises a mixture of the plurality of different materials before the second material is fed into the printer head.

40. A method according to claim 38, comprising selectively mixing a plurality of different colourants to provide a single resultant colourant and the feeding the resultant colourant to the printer head.
